(19) United States
(12) Patent Application Publication
(10) Pub. No.: US 2026/0339521 A1
(43) Pub. Date: Oct. 29, 2026

(54) OT DEVICE MEMORY END OF LIFE ALERT

(71) Applicant: Schneider Electric Systems USA, Inc., Foxborough, MA (US)

(72) Inventors: James Redmond, Richmond (CA); Zackery Sobin, Tryon, NC (US)

(21) Appl. No.: 19/190,104

(22) Filed: Apr. 25, 2025

(51) Int. Cl. G06F 3/06

(52) U.S. Cl. CPC G06F 3/0616; G06F 3/0649; G06F 3/0673

(57) ABSTRACT

A lifespan of an Operational Technology (OT) device is predicted and extended by tracking write operations performed by the OT device’s processor to the OT device’s memory. A wear leveling algorithm tracks the write operations and a counter is incremented for each of the addresses identifying the data storage locations in which the write operations stored data. In response to the count reaching a predetermined threshold, a lifespan prediction relating to the memory is generated. An alert notifies a user of the lifespan prediction.

### BACKGROUND

Operational Technology (OT) refers to hardware and software systems that are used to monitor, control, and automate physical processes in industries such as manufacturing, energy, transportation, and utilities. These technologies are designed to interact directly with physical devices, machinery, and infrastructure. In the OT environment, a process control system (PCS) (also known as an industrial control system (ICS)) monitors and controls industrial processes. The typical PCS includes a distributed control system (DCS) that includes multiple control processors (CPs) distributed through-out the industrial system for providing computerized and autonomous controls. The controls can be managed by a central operator supervisory controller, such as a supervisory control and data acquisition (SCADA) system. Each CP can supervise and control multiple field devices, such as sensors and actuators. In a large industrial system, for example, controllers can interact with a vast number of field devices, programmable logic controllers (PLCs), remote terminal units (RTUs), and the like. In addition, other instruments or physical displays of human-machine interfaces (HMIs) can incorporate elements of the ICS. OT is critical for ensuring the safe, efficient, and reliable operation of industrial and infrastructure systems and often operates in environments where real-time data and control are vital, such as in power plants, water treatment facilities, oil and gas facilities, mining operations, and the like. The main difference between OT and IT (Information Technology) is that OT focuses on physical industrial processes, while IT relates to digital information and communication.

As with other processor-based systems, OT systems have file systems for organizing and storing files on a memory storage device to ensure the files are readily accessible for use. Some file systems include wear leveling features. Memory wear leveling is a technique used in memory storage devices (such as SSDs, USB drives, and memory cards) to distribute the write and erase cycles evenly across the memory cells. Flash memory, for instance, has a limited number of write/erase cycles before it starts to wear out and become unreliable. Without wear leveling, certain memory cells would be written to or erased more frequently than others, leading to premature failure of those cells while others might remain under-utilized. Wear leveling algorithms ensure that data is written to different physical locations on the memory, so that the wear is spread out across the entire storage medium. This helps to maximize the overall lifespan of the storage device and maintain its performance.

### SUMMARY

Aspects of the present disclosure provide the use of a wear leveling system on OT devices and other equipment such as instruments, PLCs, RTUs, DCS controllers, cell modems, industrial switches/routers, data radios, instruments, HMIs, satellite modems, etc. Further aspects include the use of a wear leveling system on OT devices as a means of anticipating an OT device failure due to an internal memory failure and then alerting a user to an anticipated failure prior to condition occurring using an alarm system, e.g. predictive maintenance. The use of a wear leveling system in accordance with aspects of the present disclosure on OT devices provides a means of anticipating an OT device failure and mitigating that impact by transitioning some or all of the operations from one component of memory to another component that is new or has a significantly greater anticipated remaining lifespan.

In an aspect, a method predicts and extends a lifespan of an OT. The OT device comprises a memory having a plurality of data storage locations identified by a plurality of addresses. Each address identifies at least one of the data storage locations. The OT device further comprises a processor configured to perform write operations for storing data in the data storage locations. The method comprises tracking the write operations performed by the processor of the OT device, incrementing a counter for each of the addresses identifying the data storage locations in which the write operations stored data, and generating a lifespan prediction relating to the memory in response to the counter for the address reaching a predetermined threshold. The method also includes generating an alert to notify a user of the lifespan prediction.

In another aspect, an OT device comprises one or more memory devices having a plurality of data storage locations identified by a plurality of addresses. Each of the addresses identifies at least one of the data storage locations. The OT device also comprises a control processor coupled to the memory devices. The control processor is configured to perform write operations for storing data in the data storage locations of the memory devices. The memory devices also store processor-executable instructions that, when executed, configure the control processor for tracking the write operations performed by the control processor, generating a count of the write operations for each of the addresses identifying the data storage locations in which the write operations stored data, generating a lifespan prediction relating to the memory devices in response to the counter for at least one of the addresses reaching a predetermined threshold, and generating an alert to notify a user of the lifespan prediction.

In yet another aspect, an industrial automation system comprises a SCADA server and an OT device coupled to the SCADA server via a communications network. The SCADA server is configured to monitor data from the OT device and provide supervisory control via the communications network. The OT device comprises one or more memory devices having a plurality of data storage locations identified by a plurality of addresses. Each of the addresses identifies at least one of the data storage locations. The OT device also comprises a control processor coupled to the memory devices. The control processor is configured to perform write operations for storing data in the data storage locations of the memory devices. The memory devices also store processor-executable instructions that, when executed, configure the control processor for tracking the write operations performed by the control processor, generating a count of the write operations for each of the addresses identifying the data storage locations in which the write operations stored data, generating a lifespan prediction relating to the memory devices in response to the counter for at least one of the addresses reaching a predetermined threshold, and generating an alert to notify a user of the lifespan prediction.

Other objects and features of the present disclosure will be in part apparent and in part pointed out herein.

### BRIEF DESCRIPTION OF THE DRAWINGS

FIG. 1 illustrates an example automation system according to an embodiment.

FIG. 2 illustrates an example process for implementing wear leveling of an OT device according to an embodiment.

FIG. 3 illustrates an example subprocess of the process of FIG. 2 for monitoring write affected logical block addresses (LBAs) according to an embodiment.

FIGS. 4A and 4B illustrate an example subprocess of the process of FIG. 2 for analyzing and reporting status of a memory with finite lifespan according to an embodiment.

FIG. 5 is a block diagram illustrating an example computer system according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

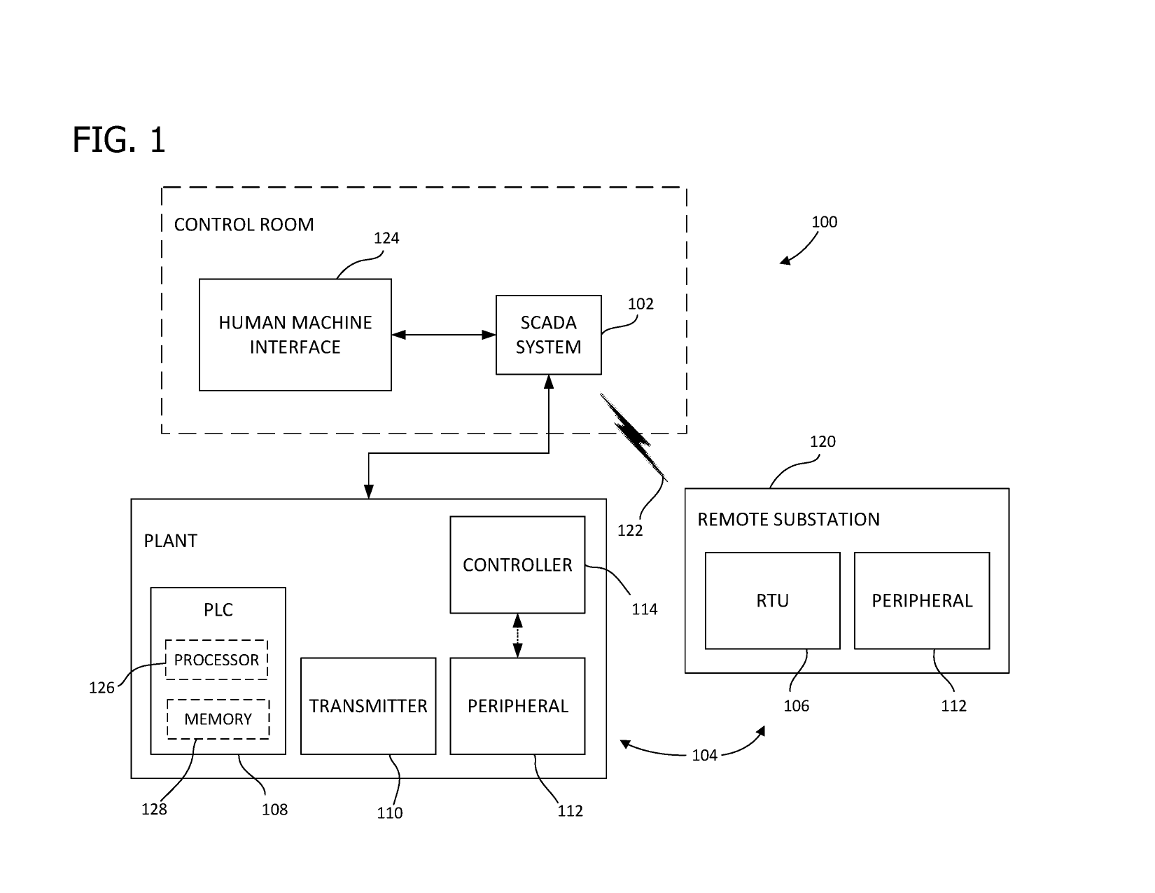

Referring to FIG. 1, a schematic overview of an automation system is generally indicated 100. The automation system 100 includes a SCADA system 102 communicating with one or more industrial assets, located locally in a plant, for example, or remotely. In the illustrated embodiment, the industrial assets include an OT device 104 for industrial control and monitoring. According to aspects of the present disclosure, the OT device 104 may be embodied by various components of the automation system 100, such as an RTU 106, a PLC 108, a multivariable transmitter (MVT) 110, a peripheral 112 (e.g., sensor, actuator, variable frequency drive, motor controller, pressure transmitter, Coriolis meter, magnetic flow meter, etc.), and/or a controller 114 (e.g., a DCS controller). In a SCADA-based control system, the PLC 108 is connected to, for example, a sensor (i.e., peripheral 112) for collecting the sensor output signals and converting the signals into digital data. The SCADA system 102 may also communicate with a transmitter, such as MVT 110, which is used to measure flow, differential pressure, temperature, pressure, and the like.

In the illustrated embodiment, the SCADA system 102 of FIG. 1 is also coupled to a remote substation 120 via a communications network 122, such as a private data radio network and/or a cellular telephone network. The substation 120 typically includes a number of peripherals 112 and at least one RTU 106 for data acquisition from substation 120 and/or from SCADA system 102. The RTU 106 transmits telemetry data to SCADA system 102 and receives messages back for controlling connected physical objects of remote substation 120.

As shown in FIG. 1, SCADA system 102 operates in conjunction with an HMI 124. The HMI 124 is an input-output device that presents process information to a human operator. The SCADA system 102 links to HMI 124 for providing maintenance procedures, detailed schematics, logistic information, trend data, diagnostic data, and the like for a specific sensor or machine. In an embodiment, HMI 124 comprises a personal computer, smartphone, tablet, touchscreen HMI device, or the like. Although illustrated in a control room remotely from the various industrial assets, it is to be understood that HMI 124 could be hosted on the device itself.

Aspects of the present disclosure provide a wear leveling system for OT device 104 and other equipment, such as instruments, PLCs 108, RTUs 106, DCS controllers 114, cell modems, industrial switches/routers, data radios, HMIs 124, satellite modems, etc. Further aspects include a predictive maintenance system for use with the wear leveling system for anticipating when OT device 104 might fail due to an internal memory failure and then alerting a user to the anticipated failure prior to such condition occurring. The use of a wear leveling system on OT devices 104 and other equipment in accordance with aspects of the present disclosure further provide for mitigating the impact of failure by transitioning some or all of the operations from one component of memory to another component of memory that is new or has a significantly greater expected remaining lifespan.

The system 100 is well-suited for use in oil and gas environments, such as upstream oil and gas production, including gas well heads, oil extraction, and multi-well shale gas well pads. Additional customer use cases in the oil and gas segment include energy optimization, asset age prolongation, production optimization, and ‘cradle-to-grave’ operation with the same equipment to allow changes in extraction technique using the same control system equipment. Oil and gas segment use cases also include: management of control system and IT equipment, including security configurations, and deployment of trusted application content; and midstream gas transportation including compressor stations and multiple geographies. The functions of remote substation 120 in an oil and gas application include, for example: tank monitoring and automation; well test automation; Emergency Shut-Down (ESD) at well heads; well production and optimization; and measurement.

In an oil and gas environment, for example, remote substation 120 may be located at a well site to gather data about various aspects of the well site for monitoring and tracking purposes. The substation 120, which acts as a control unit, includes RTU 106 for collecting data on pump motor operation (e.g., motor speed and load). A variable speed drive motor controller, for example, generates this motor data. The RTU 106 also collects measurements from various wireless and wired field sensors around the well site. These field sensors include a proximity sensor mounted near the crank arm of a rod pump assembly and a load cell mounted between the bridle and polished rod of the rod pump assembly. From this data, RTU 106 can determine the tension or load (vertical axis) on the rod versus the displacement (horizontal axis) of the rod per stroke or pump cycle (i.e., upward and downward movement). Other data collected by RTU 106 from the field sensors may include fluid flow rate, temperature, pressure, and the like.

In another embodiment, system 100 is also well-suited for use in the water/wastewater segment, including critical infrastructure pumping stations. Additional customer use cases in the water and wastewater segment include energy optimization for critical infrastructure pumping stations and management of control system and IT equipment including security configurations, and deployment of trusted application content. Examples of water and wastewater functions include: pump/lift stations; leakage detection; equipment monitoring and control; water quality monitoring; irrigation; managing a District Metering Area (DMA) and/or Pressure Monitoring Area (PMS); and monitoring flow, level, pressure, temperature, etc.

Another use case for system 100 involves autonomous assets, some located remotely, including critical infrastructure assets, where high control system, monitoring, and reporting availability as well as data analytics associated with control systems, asset performance, and custom application features are requested.

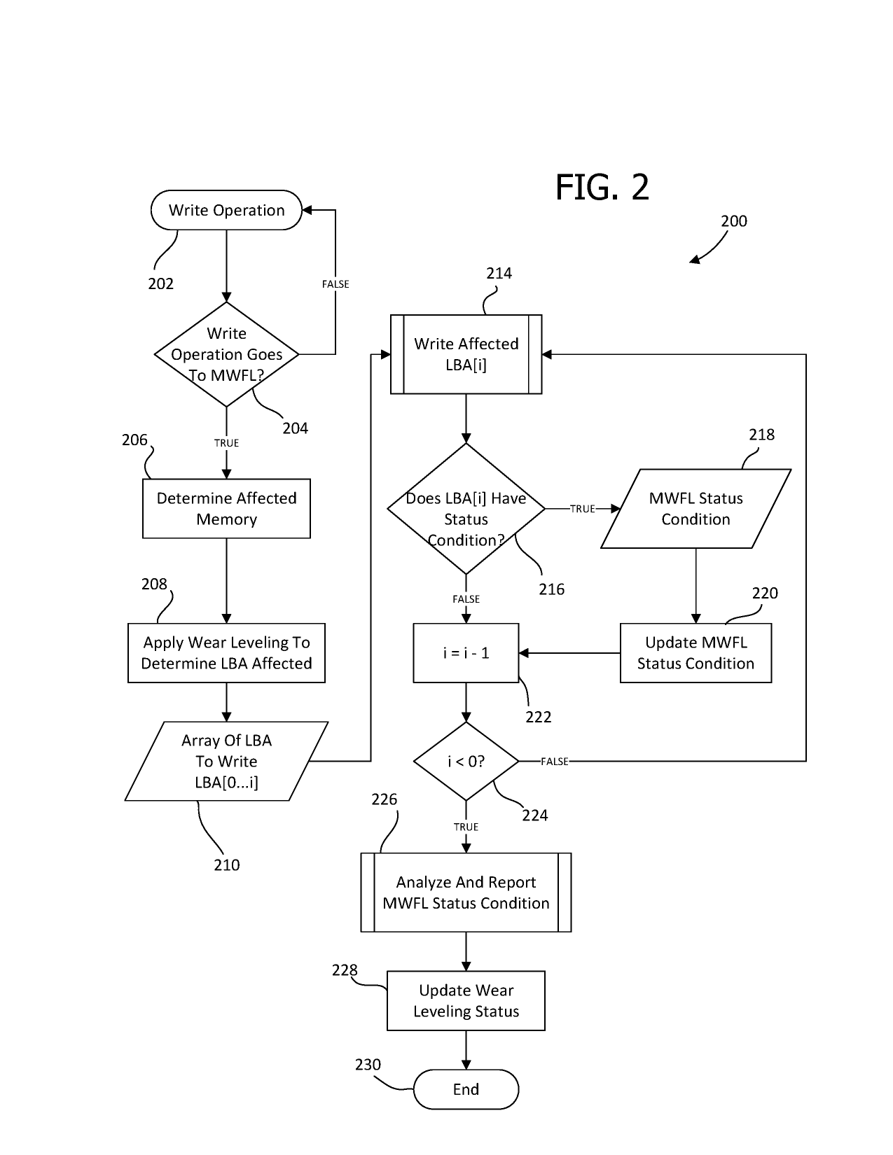

FIG. 2 illustrates an example process 200 for implementing wear leveling of an OT device 104. According to aspects of the present disclosure, the OT device 104, such as PLC 108, RTU 106, controller 114, or the like, executes a memory wear leveling algorithm to mitigate the impact of memory wear and extend the life of the automation platform. In addition, the memory wear leveling algorithm provides status information for triggering alerts, alarms, or the like to warn the user that the memory of the automation platform is approaching a condition where the device will cease functioning. For example, a processor 126 of PLC 108 is configured for executing the process of FIG. 2 to perform wear leveling of a memory device 128. It is to be understood that a processor or other computing device of automation system 100 or a cloud-based processor or computing device may be used for executing the process of FIG. 2 to implement OT wear leveling within the scope of the present disclosure.

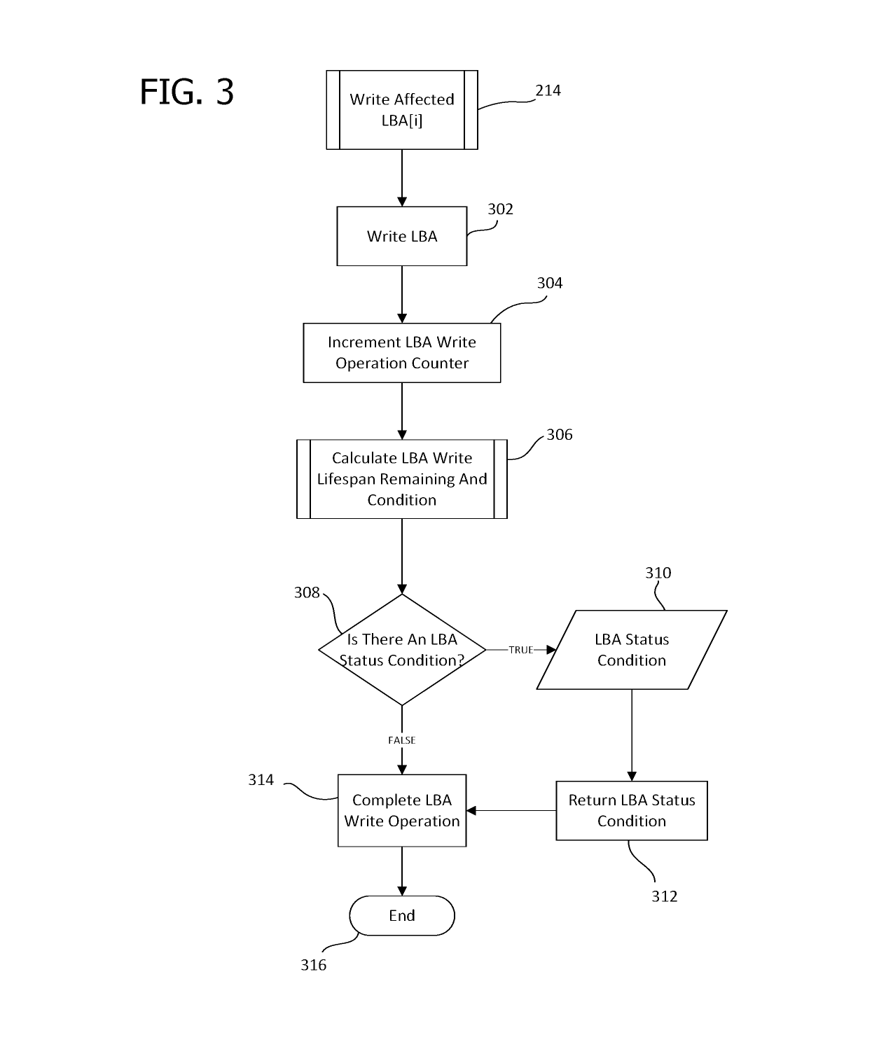

The process 200 begins at 202 in response to a write operation to be performed in memory (e.g., memory device 128). Advantageously, the OT device 104 uses dynamic or static wear leveling to monitor the number of operations performed on each memory location. In an embodiment, each physical block in a memory with finite lifespan (abbreviated “MWFL” in FIGS. 2, 3, 4A, and 4B), such as a flash memory, is linked to an LBA. At 204, the process 200 determines whether the write operation is being made to the memory 128. If so, process 200 determines the affected memory 128 at 206 and then applies wear leveling at 208 to determine which LBA of the memory 128 is affected. These operations result at 210 in an array of candidate LBAs to write, namely, LBA[0…i]. On the other hand, if the decision at 204 determines that the write operation is not being made to memory 128 with finite lifespan, process 200 returns to the write operation step at 202. At 214, the process 200 executes a write affected subprocess described in greater detail with respect to FIG. 3.

Proceeding to 216, a decision block of process 200 determines whether the write affected LBA[i] of the memory 128 has a known status condition. If so, the status condition of the memory 128 with finite lifespan is retrieved at 218 and updated with a current status condition at 220. In the illustrated embodiment, the LBA is decremented (i = i – 1) at 222 to enable determinations of the next LBA’s status condition. If LBA[i] does not have a status condition, as determined at 216, process 200 proceeds directly to decrementing the LBA at 222. In an alternative embodiment, the LBA may be incremented (e.g., begin at 0 and count up to a total number of LBAs.

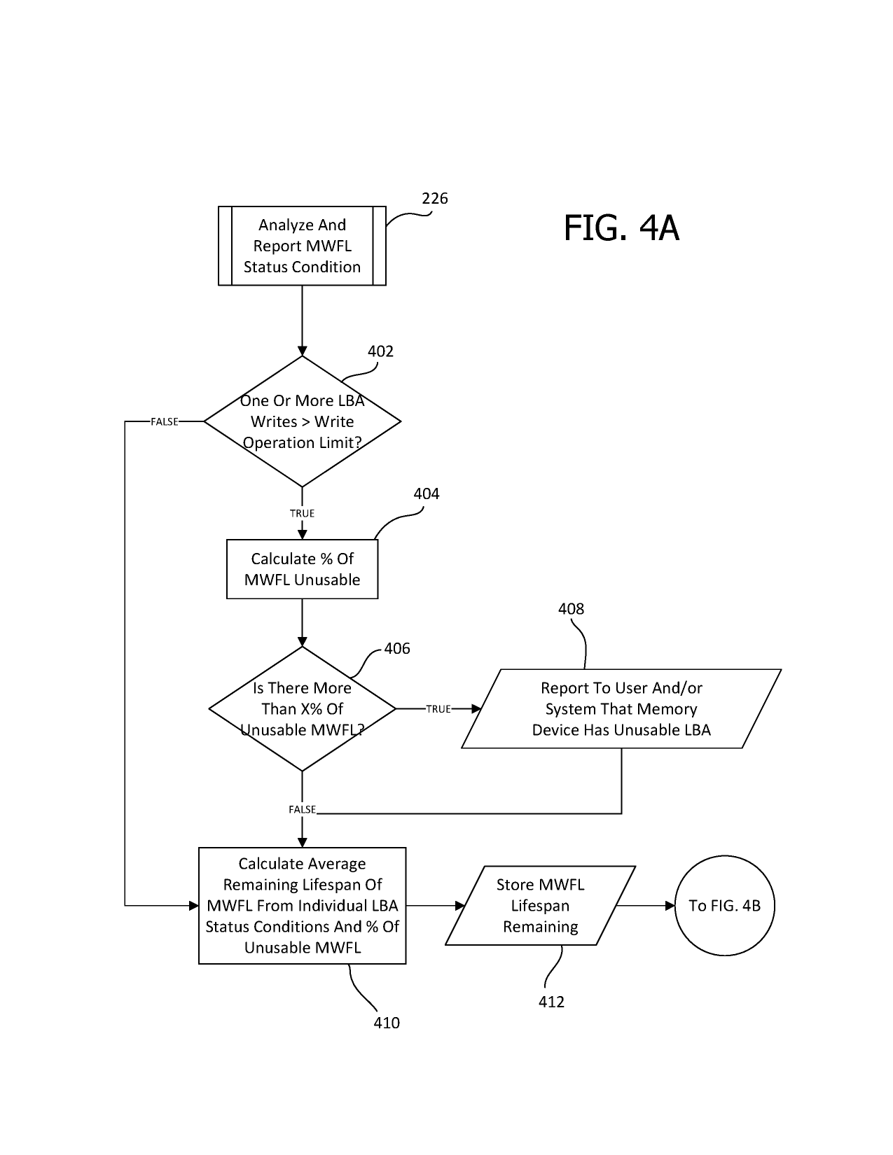

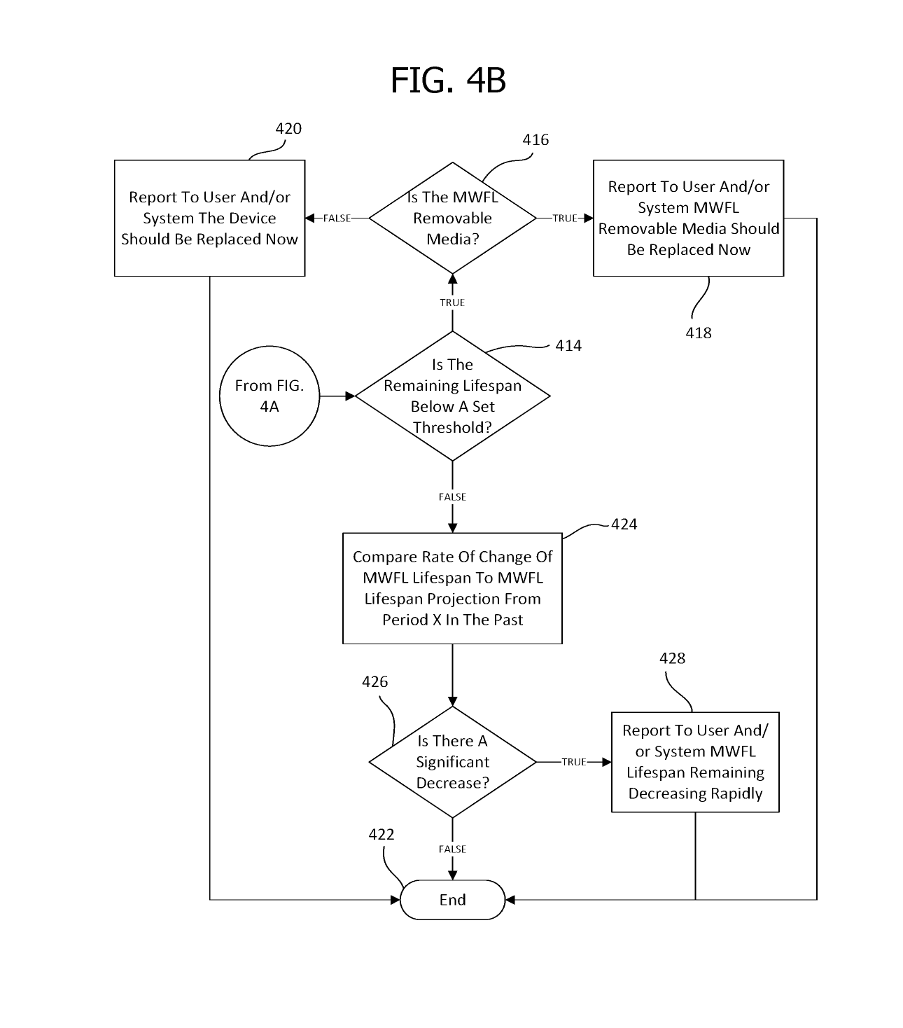

The process 200 continues at 224 for determining whether i < 0. If so, the status of all of the LBAs will have been considered and updated and a report of the memory’s status condition can be generated at 226. The subprocess 226 for analyzing and reporting the memory’s status condition is described with respect to FIGS. 4A and 4B. The process 200 updates wear leveling status and 228 and ends at 230. If the status of all of the LBAs has not been considered, as indicated by i < 0 being false at 224, the process 200 returns to the write affected LBA[i] subprocess at 214.

FIG. 3 illustrates the example subprocess at 214 for monitoring write affected LBAs according to an embodiment. At 302, a write operation to a selected LBA occurs. The subprocess 214 then increments an LBA write operation counter at 304 and initiates a subprocess at 306 to calculate the remaining write lifespan of the LBA and its condition. In an alternative embodiment, subprocess 214 decrements the LBA write operation counter at 304. If there is an LBA status condition at 308, subprocess 214 retrieves the status condition at 310 and returns it at 312 to complete the write operation to the LBA at 314. The subprocess 214 then ends at 316. On the other hand, if the decision at 308 indicates that there is not a status condition for the LBA, operations proceed directly to 314 to complete the LBA write operation before ending at 316.

FIGS. 4A and 4B illustrate the example subprocess 226 for analyzing and reporting status of the memory 128 with finite lifespan according to an embodiment. At 402, the subprocess 226 determines whether the LBA writes exceeds the write operation limit of the memory 128. If so, the subprocess 226 calculates a percentage of memory that is unusable at 404. If the percentage of unusable memory exceeds a predetermined threshold, as determined at 406, the subprocess 226 reports to the user and/or system at 408 that the memory device 128 has unusable LBA. The subprocess 226 continues at 410 for calculating the average remaining lifespan of the memory 128 from the individual LBA status conditions and the percentage of unusable memory. The remaining lifespan information is then stored at 412.

At 406, if the percentage of unusable memory does not exceed the predetermined threshold, operations proceed directly to 410 for calculating the average remaining lifespan of the memory 128 from the individual LBA status conditions and the percentage of unusable memory. Similarly, if the subprocess 226 determines at 402 that the write operation limit has not been exceeded, operations proceed directly to 410 for calculating the average remaining lifespan of the memory 128 from the individual LBA status conditions and the percentage of unusable memory.

Proceeding to FIG. 4B, subprocess 226 determines at 414 whether the memory’s remaining lifespan falls below a predetermined threshold. If so, the subprocess 226 identifies at 416 whether the memory 128 with finite lifespan is removable media. At 418, an alert indicates to the user and/or system that the removable media should be replaced now based on the insufficient remaining lifespan. On the other hand, if the subprocess 226 identifies at 416 that the memory 128 with finite lifespan is not removable media, an alert indicates to the user and/or system at 420 that the memory device 128 itself should be replaced now based on the insufficient remaining lifespan. The subprocess 226 then ends at 420.

If the memory’s remaining lifespan does not fall below the predetermined threshold, as determined at 414, the subprocess 226 compares a rate of change of the memory’s lifespan to a lifespan projection from a preselected period in the past at 424. Proceeding to 426, subprocess 226 determines if there is a significant decrease in the rate of change relative to the projection. If so, the user and/or system is alerted to the memory’s rapidly decreasing lifespan at 428 and otherwise proceeds to end at 422.

As described above, many OT systems rely heavily on forms of memory that are susceptible to memory wear, which leads to their failure. A benefit of memory wear leveling in accordance with aspects of the present disclosure is the provision of a mechanism to alert the user either directly or via SCADA system 102 that memory wear is such that the device should be serviced or replaced to avoid risking device failure while in service. In some cases, the OT device 104 is configured to contact operators directly using text messaging, email, or another messaging system as a supplement or backup to SCADA system 102. As OT systems are often associated with critical infrastructure such as water and energy, this in turn provides users and their consumers with more reliable access to critical infrastructure.

Aspects of the present disclosure incorporate such a system into an OT device 104 with the addition of a software or firmware feature to track the number of write operations performed on each LBA of the device’s memory 128. Thus, each time the CPU(s) of the OT device 104 performs a write operation, a count for the affected LBA(s) increments. Although described in the context of the LBA scheme, it is to be understood that tracking the number of write operations performed on each address of the device’s memory 128 may employ other memory addressing schemes within the scope of the present disclosure. For example, alternatives to LBA include Physical Block, Page Mapping, Hybrid (mixed page or physical and block), NAND Flash, and NOR Flash. As the count of write operations approaches a threshold of concern, an automated action can be taken.

In an embodiment, this automated action includes issuing an alarm or status message or other form of alert advising the user. For example, the alert is issued via SCADA system 102 or directly via OT device 104 to replace the memory device 128 (in the case of removable media) or to replace the OT device 104 altogether in the case of memory inherent to the device. The automated action may be taken in response to the alarm or status message to extend the life of the memory device or switch over to an alternate memory device (in situations where there is more than one memory device) to ensure seamless operation of the system/device. Further to the example, suitable actions include: replacing an SD Card; servicing the device (e.g., replacing the module containing the memory); reconfiguring the device or system to slow memory life consumption, change the memory storage location, reduce parameters being stored, etc.; and replacing the device with a fresh one. Other automated actions in accordance with one or more embodiments include: causing the device to enter a distressed memory mode, where it slows memory life consumption, by only storing key items rather than the whole range of parameters or storing information less frequently; causing the device to switch from one piece of memory to another (e.g., from on-board memory to an SD Card); and causing the device to slow its control loop to reduce memory operations.

The threshold varies with the physical characteristics of the underlying memory device 128 (e.g., 80% of the expected number of write operations the OT device 104). According to one or more embodiments, the threshold of concern may be a preset percentage of the number of write operations specified by the manufacturer of memory 128 or determined empirically through testing of such memory devices.

An additional aspect could be the OT device 104 incorporates multiple redundant physical memory components. Thus as the memory 128 of concern approaches it's write limit, the OT device 104 could activate another section or component of memory 128, transfer its operations to that new component, and continue operating thereafter.

In an embodiment, a method for predicting and extending the end of life of a memory device 128 in an OT device 104, comprises tracking the number of write operations performed on each LBA of the memory device 128 in the OT device 104 using a wear leveling system and incrementing a count for the affected LBA(s) each time the OT device 104 CPU(s) performs a write operation. For instance, executing a wear leveling algorithm comprises means for tracking the write operations and/or extending the lifespan of the memory. In response to the count of write operations approaching a threshold of concern, which is indicative of the end of life of the memory device 128, and which will vary with the physical characteristics of the underlying memory device, the method includes taking at least one action to warn about the end of life of the memory device 128 or extend the life of the memory device.

### Example Computing Environment:

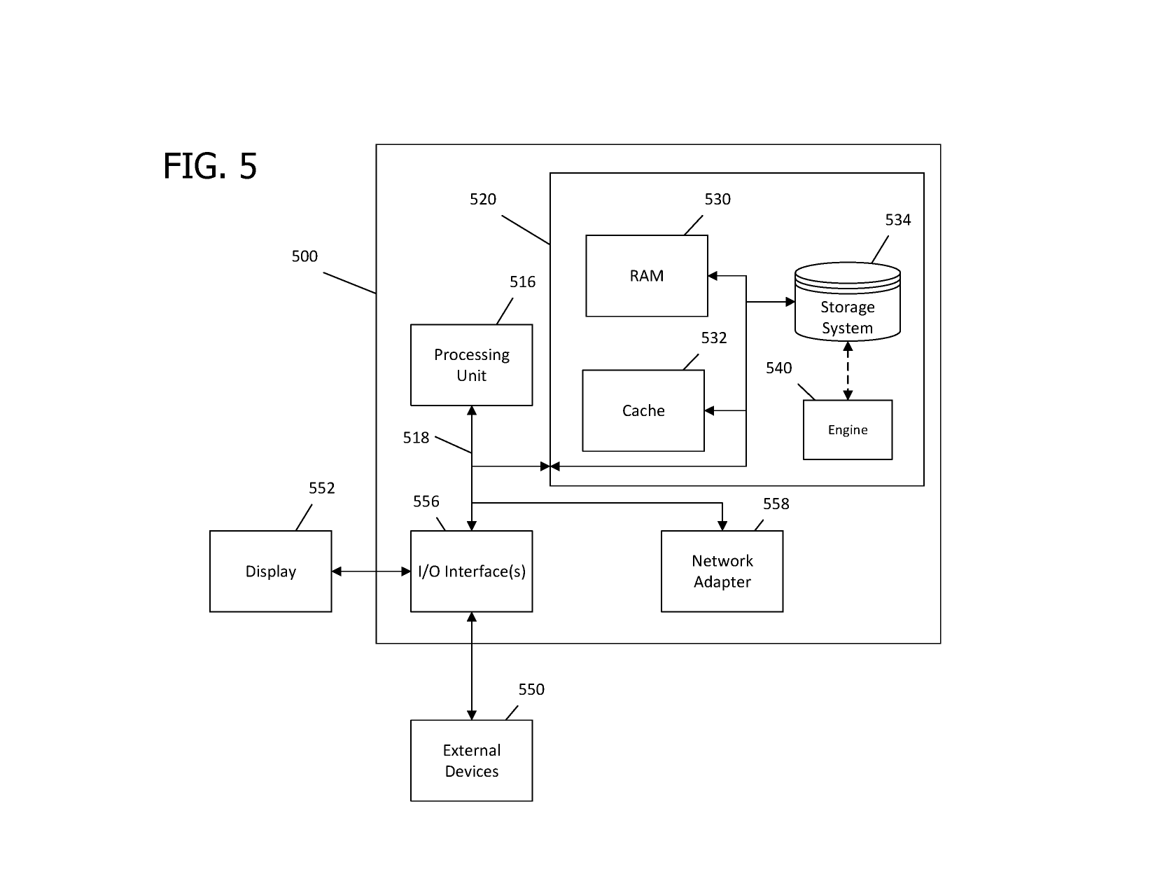

A computer system 500 is shown in FIG. 5 in the form of a general-purpose computing device. The components of the computer system 500 may include, but are not limited to, one or more processors or processing units 516, a bus 518, and a system memory 520. In the illustrated embodiment, the bus 518 couples various system components such as the system memory 520 to the processor 516. In an embodiment, the OT device 104 comprises one or more components of a computing or processing system such as illustrated in the computer system 500 of FIG. 5.

The bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

According to one or more embodiments, computer system 500 typically includes a variety of computer-readable media. Such media may be any available media that is accessible by computer system 500, and it includes both volatile and non-volatile media, removable and non-removable media.

The system memory 520 can include computer-readable media in the form of volatile memory, such as random-access memory (RAM) 530 and/or cache memory 532. The computer system 500 may further include other removable/non-removable, volatile/non-volatile computer system storage media. By way of example only, a storage system 534 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 520 may include at least one program product having a set (e.g., at least one) of program modules that are configured to carry out the functions of embodiments of the disclosure.

The computer system 500 may also communicate with one or more external devices 550 such as a keyboard, a pointing device, a display 552, etc.; one or more devices that enable a user to interact with computer system 500; and/or any devices (e.g., network card, modem, etc.) that enable computer system 500 to communicate with one or more other computing devices. Such communication can occur via Input/Output (I/O) interfaces 556. Still yet, computer system 500 can communicate with one or more networks such as a LAN, a general WAN, and/or a public network (e.g., the Internet) via a network adapter 558. As depicted, the network adapter 558 communicates with the other components of a network (not shown) via bus 518. It should be understood that although not shown, other hardware and/or software components could be used in conjunction with computer system 500. Examples, include, but are not limited to: microcode, device drivers, redundant processing units, external disk drive arrays, RAID systems, tape drives, and data archival storage systems, and so on.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the disclosure are operational with other special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored in memory, i.e., one or more tangible, non-transitory storage media, and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the disclosure.

When introducing elements of the disclosure or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure are not limited in its application to the details of construction and the arrangement of components set forth in the following description or illustrated in the drawings. The aspects of the disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the disclosure defined in the appended claims. As various changes could be made in the above constructions and methods without departing from the scope of the disclosure, it is intended that all matter contained in the above description and shown in the accompanying drawings shall be interpreted as illustrative and not in a limiting sense.

In view of the above, it will be seen that several advantages of the aspects of the disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A method for predicting and extending a lifespan of an Operational Technology (OT) device, the OT device comprising a memory having a plurality of data storage locations identified by a plurality of addresses, wherein each of the addresses identifies at least one of the data storage locations, the OT device further comprising a processor configured to perform one or more write operations for storing data in the data storage locations, the method comprising:
tracking the write operations performed by the processor of the OT device;
incrementing a counter for each of the addresses identifying the data storage locations in which the write operations stored data;
in response to the counter for at least one of the addresses reaching a predetermined threshold, generating a lifespan prediction relating to the memory; and
generating an alert to notify a user of the lifespan prediction.

2. The method of claim 1, further comprising assigning the memory addresses by logical block addressing (LBA).

3. The method of claim 1, wherein the lifespan prediction indicates an expected end of life of the memory based on a remaining number of write operations for storing data in at least one of the data storage locations before a predicted failure of the memory.

4. The method of claim 3, wherein the remaining number of write operations before the predicted failure of the memory is a function of physical characteristics of the memory.

5. The method of claim 1, wherein generating the alert comprises providing status information relating to a status of the memory as a function of the number of write operations performed thereon.

6. The method of claim 1, wherein the OT device comprises at least one of programmable logic controller, a remote terminal unit, a multivariable transmitter, a distributed control system controller, a cell modem, an industrial switch/router, a data radio, a process control instrument, a human machine interface, or a satellite modem.

7. The method of claim 1, further comprising determining the predetermined threshold as a percentage of a maximum number of write operations specified for the memory.

8. An Operational Technology (OT) device, comprising:
one or more memory devices having a plurality of data storage locations identified by a plurality of addresses, wherein each of the addresses identifies at least one of the data storage locations; and
a control processor coupled to the one or more memory devices, the control processor configured to perform one or more write operations for storing data in the data storage locations of the one or more memory devices,
wherein the one or more memory devices store processor-executable instructions that, when executed, configure the control processor for:
tracking the write operations performed by the control processor;
generating a count of the write operations for each of the addresses identifying the data storage locations in which the write operations stored data;
in response to the count for at least one of the addresses reaching a predetermined threshold, generating a lifespan prediction relating to the one or more memory devices; and
generating an alert to notify a user of the lifespan prediction.

9. The OT device of claim 8, wherein the memory addresses are assigned by logical block addressing (LBA).

10. The OT device of claim 8, wherein the one or more memory devices store processor-executable instructions that, when executed, further configure the control processor for executing a wear leveling algorithm to track the write operations and extend the lifespan of the one or more memory devices.

11. The OT device of claim 8, wherein the lifespan prediction indicates an expected end of life of the memory based on a remaining number of write operations for storing data in at least one of the data storage locations before a predicted failure of the one or more memory devices.

12. The OT device of claim 11, wherein the remaining number of write operations before the predicted failure of the one or more memory devices is a function of physical characteristics thereof.

13. The OT device of claim 8, wherein the one or more memory devices store processor-executable instructions that, when executed, further configure the control processor for providing status information relating to a status of the one or more memory devices as a function of the number of write operations performed thereon to generate the alert.

14. The OT device of claim 8, wherein the predetermined threshold is a percentage of a maximum number of write operations specified for the one or more memory devices.

15. An industrial automation system, comprising:
a Supervisory Control and Data Acquisition (SCADA) server;
an Operational Technology (OT) device coupled to the SCADA server via a communications network, wherein the SCADA server is configured to monitor data from the OT device and provide supervisory control via the communications network, the OT device, comprising:
one or more memory devices having a plurality of data storage locations identified by a plurality of addresses, wherein each of the addresses identifies at least one of the data storage locations; and
a control processor coupled to the one or more memory devices, the control processor configured to perform one or more write operations for storing data in the data storage locations of the one or more memory devices,
wherein the one or more memory devices store processor-executable instructions that, when executed, configure the control processor for:
tracking the write operations performed by the control processor;
generating a count of the write operations for each of the addresses identifying the data storage locations in which the write operations stored data;
in response to the count for at least one of the addresses reaching a predetermined threshold, generating a lifespan prediction relating to the one or more memory devices; and
generating an alert to notify a user of the lifespan prediction.

16. The industrial automation system of claim 15, wherein the memory addresses are assigned by logical block addressing (LBA).

17. The industrial automation system of claim 15, wherein the OT device comprises at least one of programmable logic controller, a remote terminal unit, a multivariable transmitter, a distributed control system controller, a cell modem, an industrial switch/router, a data radio, a process control instrument, a human machine interface, or a satellite modem.

18. The industrial automation system of claim 15, wherein the one or more memory devices store processor-executable instructions that, when executed, further configure the control processor for executing a wear leveling algorithm to track the write operations and extend the lifespan of the one or more memory devices.

19. The industrial automation system of claim 18, wherein the lifespan prediction indicates an expected end of life of the memory based on a remaining number of write operations for storing data in at least one of the data storage locations before a predicted failure of the one or more memory devices.

20. The industrial automation system of claim 15, wherein the one or more memory devices store processor-executable instructions that, when executed, further configure the control processor for providing status information relating to a status of the one or more memory devices as a function of the number of write operations performed thereon to generate the alert.
